(19) United States
(12) Patent Application Publication
(10) Pub. No.: US 2024/0281284 A1
(43) Pub. Date: Aug. 22, 2024

(54) TASK PROCESSING METHODS AND APPARATUSES

(71) Applicant: Beijing Volcano Engine Technology Co., Ltd., Beijing (CN)

(72) Inventors: Leilei HU, Beijing (CN); Fachuan BAI, Beijing (CN); Xuan LUO, Beijing (CN)

(21) Appl. No.: 18/571,133

(22) PCT Filed: Mar. 9, 2023
(86) PCT No.: PCT/CN2023/080489

§ 371 Date: Dec. 15, 2023

(30) Foreign Application Priority Data
Mar. 17, 2022 (CN) 202210265806.8

(51) Int. Cl. G06F 9/48

(52) U.S. Cl. CPC G06F 9/4881

(57) ABSTRACT

This application provides a task processing method, a first server may receive a first task processing request sent by a client, and then determine information of a task engine that is used to processes the first task processing request. The information of the task engine may be used to establish a connection to the task engine. The first server may store the information of the task engine and an identifier of the client in correspondence into an external memory. After the first server is faulty, another server may determine the information of the task engine based on the information of the task engine and the identifier of the client that are stored correspondingly in the external memory, and establish a connection to the task engine based on the information of the task engine, to use the task engine to continue to process a task initiated by the client.

This application claims priority to Chinese Patent Application No. 202210265806.8, filed with the China National Intellectual Property Administration on Mar. 17, 2022 and entitled “TASK PROCESSING METHODS AND APPARATUSES”, which is incorporated herein by reference in its entirety.

### TECHNICAL FIELD

This application relates to the field of computer technologies, and in particular, to a task processing method and apparatus.

### BACKGROUND

In some scenarios, a client may send a task processing request to a server, and the server processes the task. In an example, the server may process the task by using a task engine.

Currently, if a processing time of a task is long, in a process of processing the task, if the server is faulty, even if the task engine runs normally, the task is forced to end, and the task needs to be reprocessed once again, so that the reliability of task processing is relatively low.

Therefore, a solution is urgently required, to resolve the foregoing problem.

### SUMMARY

The technical problem to be resolved in this application is how to improve reliability of task processing, and a task processing method and apparatus are provided.

In one aspect, a task processing method is provided by an embodiment of the application, the method is applied to a first server, and the method includes:
receiving a first task processing request sent by a client;
determining information of a task engine that is used to process the first task processing request; and
storing the information of the task engine and an identifier of the client correspondingly into an external memory.

Optionally, the method further includes:

storing the first task processing request and the identifier of the client correspondingly into the external memory.

Optionally, storing the first task processing request and the identifier of the client correspondingly into the external memory includes:
when the first task processing request is related to a task execution environment, storing the first task processing request and the identifier of the client correspondingly into the external memory.

Optionally, the method further includes:

receiving a connection request sent by the client, wherein the connection request comprises the identifier of the client.

Optionally, the information of the task engine includes:

an IP address and a port number of the task engine.

Optionally, the information of the task engine further includes:

an identifier of the task engine.

Optionally, the first server is a HiveServer2.

Optionally, the first task processing request is a structured query language SQL statement, and the task engine is an application master AM.

Optionally, the external memory is a memory of a ZooKeeper.

In second aspect, a task processing method is provided by an embodiment of the application, the method is applied to a second server, and the method includes:

receiving a second task processing request sent by a client;

searching information of a task engine from an external memory based on an identifier of the client, wherein a correspondence relationship between the information of the task engine and the identifier of the client is stored in the external memory; and

establishing a connection to the task engine based on the information, that is obtained by the searching, of the task engine, and processing the second task processing request by using the task engine.

Optionally, the method further includes:

searching a historical task processing request corresponding to the client from the external memory based on the identifier of the client, wherein the historical task processing request comprises a request that is related to a task execution environment, and the external memory comprises a correspondence relationship between the identifier of the client and the historical task processing request; and

processing the request that is related to the task execution environment and that is obtained by the searching.

Optionally, the method further includes:

receiving a connection request sent by the client, wherein the connection request comprises the identifier of the client.

Optionally, the information of the task engine includes:

an IP address and a port number of the task engine.

Optionally, the information of the task engine further includes:

an identifier of the task engine.

Optionally, the second server is a HiveServer2.

Optionally, the second task processing request is a structured query language SQL statement, and the task engine is an application master AM.

Optionally, the external memory is a memory of a ZooKeeper.

In third aspect, a task processing method is provided by an embodiment of the application, and the method includes:
receiving, by a first server, a first task processing request sent by a client;
determining, by the first server, information of a task engine that is used to process the first task processing request;
storing, by the first server, the information of the task engine and an identifier of the client correspondingly into an external memory;
receiving, by a second server, a second task processing request sent by the client,
after the first server is faulty;
searching, by the second server, the information of the task engine from the external memory based on the identifier of the client; and
establishing, by the second server, a connection to the task engine based on the information, that is obtained by searching, of the task engine, and processing the second task processing request by using the task engine.

The fourth aspect, a task processing apparatus is provided by an embodiment of the application, the apparatus is applied to a first server, and the apparatus includes:
a first receiving unit, configured to receive a first task processing request sent by a client;
a determining unit, configured to determine information of a task engine that is used to process the first task processing request; and
a first storage unit, configured to store the information of the task engine and an identifier of the client correspondingly into an external memory.

Optionally, the apparatus further includes:

a second storage unit, configured to store the first task processing request and the identifier of the client correspondingly into the external memory.

Optionally, the second storage unit is configured to:
when the first task processing request is related to a task execution environment, store the first task processing request and the identifier of the client correspondingly into the external memory.

Optionally, the apparatus further includes:

a second receiving unit, configured to receive a connection request sent by the client, and the connection request includes the identifier of the client.

Optionally, the information of the task engine includes:

an IP address and a port number of the task engine.

Optionally, the information of the task engine further includes:

an identifier of the task engine.

Optionally, the first server is a HiveServer2.

Optionally, the first task processing request is a structured query language SQL statement, and the task engine is an application master AM.

Optionally, the external memory is a memory of a ZooKeeper.

The fifth aspect, a task processing apparatus is provided by an embodiment of the application, the apparatus is applied to a second server, and the apparatus includes:
a first receiving unit, configured to receive a second task processing request sent by a client;
a first searching unit, configured to search information of a task engine from an external memory based on an identifier of the client, wherein a correspondence relationship between the information of the task engine and the identifier of the client is stored in the external memory; and
a first processing unit, configured to: establish a connection to the task engine based on the information, that is obtained by searching, of the task engine, and process the second task processing request by using the task engine.

Optionally, the apparatus further includes:
a second searching unit, configured to search a historical task processing request corresponding to the client from the external memory based on the identifier of the client, the historical task processing request includes a request related to a task execution environment, and the external memory includes a correspondence relationship between the identifier of the client and the historical task processing request; and
a second processing unit, configured to process the request that is related to the task execution environment and that is obtained by searching.

Optionally, the apparatus further includes:

a second receiving unit, configured to receive a connection request sent by the client, and the connection request includes the identifier of the client.

Optionally, the information of the task engine includes:

an IP address and a port number of the task engine.

Optionally, the information of the task engine further includes:

an identifier of the task engine.

Optionally, the second server is a HiveServer2.

Optionally, the second task processing request is a structured query language SQL statement, and the task engine is an application master AM.

Optionally, the external memory is a memory of a ZooKeeper.

The sixth aspect, a task processing apparatus is provided by an embodiment of the application, and the apparatus includes:

a first receiving unit, a determining unit, and a first storage unit that are applied to a first server; and a second receiving unit, a searching unit, and a processing unit that are applied to a second server;

the first receiving unit is configured to receive a first task processing request sent by a client;

the determining unit is configured to determine information of a task engine that is used to process the first task processing request;

the first storage unit is configured to store the information of the task engine and an identifier of the client correspondingly into an external memory;

the second receiving unit is configured to: receive a second task processing request sent by the client, after the first server is faulty;

the searching unit is configured to search the information of the task engine from the external memory based on the identifier of the client; and

the processing unit is configured to: establish a connection to the task engine based on the information, that is obtained by searching, of the task engine, and process the second task processing request by using the task engine.

The seventh aspect, a device is provided by an embodiment of the application, and the device includes a processor and a memory; and

the processor is configured to perform instructions stored in the memory, so that the device performs the method as described in any one of the first aspect above, or the device performs the method as described in any one of the second aspect above, or the device performs the method as described in any one of the third aspect above.

The eighth aspect, a computer-readable storage medium is provided by an embodiment of the application, the computer-readable storage medium includes instructions, and the instructions instruct a device to perform the method as described in any one of the first aspect above, or the instructions instruct a device to perform the method as described in any one of the second aspect above, or the instructions instruct a device to perform the method as described in any one of the third aspect above.

The ninth aspect, a computer program product is provided by an embodiment of the application, and when the computer program product is run on a computer, the computer is enabled to perform the method as described in any one of the first aspect above, or the computer is enabled to perform the method as described in any one of the second aspect above, or the computer is enabled to perform the method as described in any one of the third aspect above.

Embodiments of this application have the following advantages compared with the prior art.

An embodiment of this application provides a task processing method. The method may be performed by a first server. In an example, the first server may receive a first task processing request sent by a client, and then determine information of a task engine that is used to process the first task processing request. The information of the task engine may be used to establish a connection to the task engine. Further, the first server may store the information of the task engine and an identifier of the client correspondingly into an external memory. In this way, after the first server is faulty, another server may determine the information of the task engine based on the information of the task engine and the identifier of the client that are stored correspondingly in the external memory, and further establish a connection to the task engine based on the information of the task engine, so as to use the task engine to continue to process the task initiated by the client. It can be learned that, in this solution, even if the first server is faulty, processing of the task initiated by the client is not interrupted, so that reliability of task processing is improved.

An embodiment of this application provides a task processing method. The method may be performed by a second server. In an example, the second server may receive a second task processing request sent by a client, and then search information of a task engine from an external memory based on an identifier of the client. The external memory stores a correspondence relationship between the information of the task engine and the identifier of the client. After determining the information of the task engine, the second server may establish a connection to the task engine based on the information of the task engine, and process the second task processing request by using the task engine. It can be seen from the foregoing description that, using this solution, when the first server that processes the task initiated by the client is faulty, the second server may determine the information of the task engine, so as to further process the second task processing request by using the task engine, thereby avoiding an interrupt in processing of the task initiated by the client, and improving reliability of task processing.

An embodiment of this application provides a task processing method. A first server may receive a first task processing request sent by a client, and then determine information of a task engine that is used to process the first task processing request. The information of the task engine may be used to establish a connection to the task engine. Further, the first server may store the information of the task engine and an identifier of the client correspondingly into an external memory. In this way, after the first server is faulty, a second server may receive a second task processing request sent by the client, and then search the information of the task engine from the external memory based on the identifier of the client. After determining the information of the task engine, the second server may establish a connection to the task engine based on the information of the task engine, and process the second task processing request by using the task engine. It can be seen from the foregoing description that, using this solution, when the first server that processes the task initiated by the client is faulty, the second server may determine the information of the task engine, so as to further process the second task processing request by using the task engine, thereby avoiding an interrupt in processing of the task initiated by the client, and improving reliability of task processing.

### BRIEF DESCRIPTION OF THE DRAWINGS

To describe the technical solutions in the embodiments of the present application or in the prior art more clearly, the accompanying drawings required in the description of the embodiments or the prior art will be described briefly below. Apparently, the accompanying drawings in the following description are only some examples recorded in this application, other accompanying drawings can also be derived from these drawings by those ordinarily skilled in the art without creative efforts.

FIG. 1 is a schematic diagram of an application scenario provided by an embodiment of this application;

FIG. 2 is a schematic flowchart of a task processing method provided by an embodiment of this application;

FIG. 3 is a schematic flowchart of another task processing method provided by an embodiment of this application;

FIG. 4 is a signaling interaction diagram of a task processing method provided by an embodiment of this application;

FIG. 5 is a schematic diagram of a structure of a task processing apparatus provided by an embodiment of this application;

FIG. 6 is a schematic diagram of a structure of a task processing apparatus provided by an embodiment of this application; and

FIG. 7 is a schematic diagram of a structure of a task processing apparatus provided by an embodiment of this application.

### DETAILED DESCRIPTION

In order to make those skilled in the art better understand the solution of the application, the technical solution in the embodiment of the application will be described clearly and completely with the accompanying drawings. Obviously, the described embodiment is only a part of the embodiments of the application, but not the whole embodiments. Based on the embodiments in this application, all other embodiments obtained by those ordinarily skilled in the art without creative work belong to the protection scope of this application.

For ease of understanding, a possible application scenario of embodiments of this application is first briefly described.

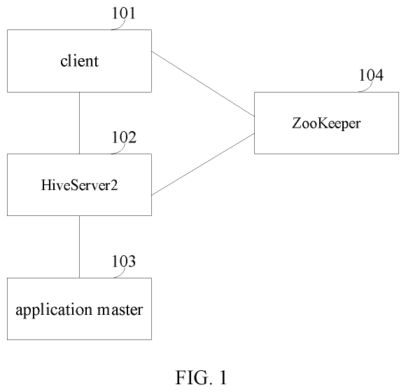

FIG. 1 is a schematic diagram of an application scenario provided by an embodiment of this application. As shown in FIG. 1, a client 101 may send a structured query language (SQL) statement to a HiveServer2 102. The HiveServer2 102 parses the SQL statement, and converts the SQL statement into a map or reduce task, and then the map or reduce task is processed by using a task engine application master (Application Master, AM) 103.

The HiveServer2 102 is a server for hive. Hive is a data warehouse analysis system built based on Hadoop and provides rich SQL query modes to analyze data stored in a Hadoop distributed file system. Hive is not described in detail herein.

In addition, the client 101 and the HiveServer2 102 may interact with a ZooKeeper 104. The ZooKeeper 104 is a distributed and highly-available coordination service. The ZooKeeper 104 may provide a load balance function for hive. The HiveServer2 102 may store its corresponding Internet Protocol (IP) address and port number (Port) to the ZooKeeper 104. When the client 101 is connected to the HiveServer2 102, the IP address of the HiveServer2 102 is obtained by using the ZooKeeper 104, to connect to the HiveServer2 102. When a plurality of HiveServers2 are deployed, the client 101 is randomly connected to one HiveServer2, thereby implementing a load balance function.

The HiveServer2 is often used in offline data warehouse scenarios. In this case, it takes relatively long time for the HiveServer2 to process tasks. However, after the HiveServer2 is faulty, an entire task is forced to end even if the AM can process the task normally. For example, after the task is processed for an hour, because of a fault of HiveServer2, the task is forced to stop.

Therefore, the task processing mode of the current HiveServer2 results in low reliability of task processing.

To resolve the foregoing problem, embodiments of this application provide a task processing method and apparatus.

It should be noted that, FIG. 1 is merely a possible application scenario of embodiments of this application. Application scenarios of embodiments of this application are not limited to the scenario shown in FIG. 1.

The following describes in detail various non-restrictive implementations with reference to the accompanying drawings.

### Exemplary Methods

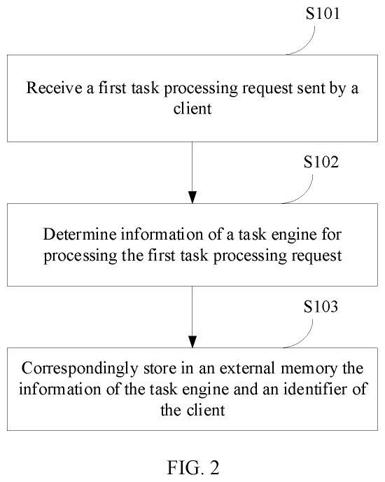

FIG. 2 is a schematic flowchart of a task processing method provided by an embodiment of this application. The method shown in FIG. 2 may be performed by a first server. The first server is not specifically limited in this embodiment of this application. In an example, in the case where the method shown in FIG. 2 is applied to the application scenario shown in FIG. 1, the first server may be the HiveServer2. Certainly, the first server may also be another server, which is not specifically limited in this embodiment of this application.

The method, for example, may include the following steps: S101-S103.

S101: Receiving a first task processing request sent by a client.

In an example, the client may establish a connection to a first server before sending the first task processing request to the first server. As an example, the client may send a connection request to the first server. The connection request may include an identifier of the server. After receiving the connection request, the first server may store the identifier of the client. For example, the identifier of the client is stored into an external memory.

After establishing the connection between the client and the first server, the client may send the first task processing request to the first server for requesting the first server to process a corresponding task. In an example, in the case where the method shown in FIG. 2 is applied to the scenario shown in FIG. 1, the first task processing request may be an SQL statement.

S102: Determining information of a task engine that is used to process the first task processing request.

S103: Storing the information of the task engine and an identifier of the client correspondingly into an external memory.

After receiving the first task processing request, the client may process a task corresponding to the first task processing request by using the task engine. In an example, the first server may be connected to the task engine (that is, the task engine is started), and after being connected to the task engine, the first server processes the task corresponding to the first task processing request by using the task engine. In the scenario shown in FIG. 1, the task engine may be an AM. As an example, the first server may parse the SQL statement to obtain a corresponding map or reduce task and process the map or reduce task by using the AM.

In this embodiment of this application, after receiving the first task processing request, the client may first search the external memory based on the identifier of the client, and in the case where information of the task engine corresponding to the identifier of the client is found by searching, a corresponding task engine is connected based on the information of the task engine. In the case where the information of the task engine corresponding to the identifier of the client is not found by searching, the client may establish a connection to one of randomly selected task engines.

In this embodiment of this application, to enable the task corresponding to the client to be processed normally when the first server is faulty, the first server may store the information of the task engine that is used to processes the first task processing request and the identifier of the client correspondingly into the external memory. In this way, when the first server is faulty, another server can find the information of the task engine from the external memory, so as to establish a connection to the task engine based on the information of the task engine, thereby continuing to use the task engine to process the task corresponding to the client.

In an example, after the task engine is started, the client may receive the information of the task engine sent by the task engine. The information of the task engine may be used to establish a connection to the task engine. In the scenario shown in FIG. 1, the first server may invoke a Hadoop interface to start the task engine and further receive the information of the task engine returned by the task engine.

The information of the task engine is not specifically limited in this embodiment of this application. In an example, considering that a connection to the task engine may be established by using an IP address and a port number of the task engine, the information of the task engine may include the IP address and the port number of the task engine.

In another example, the information of the task engine may also be used to view log information of the task engine. When the log information of the task engine is viewed, an identifier of the task engine is often used as an index. Therefore, the information of the task engine may further include the identifier of the task engine.

With respect to the external memory, it should be noted that the external memory is not specifically limited in this embodiment of this application, and as long as the external memory can be used to store information. In an example, for the scenario shown in FIG. 1, the external memory may be, for example, a memory of a ZooKeeper.

In an example, considering that if the first server is faulty, a second server is used to process the task corresponding to the client, and in this case, the second server may need to reprocess a portion of tasks that have been processed, for example, need to reprocess a task related to a task execution environment. The task related to the task execution environment may be, for example, a database table that needs to be accessed.

In view of the this, in this embodiment of this application, the first server may also store the first task processing request and the identifier of the client correspondingly into the external memory. In this way, after the first server is faulty, the second server connected to the client may obtain the first task processing request from the external memory. Correspondingly, when the first task processing request is related to the task execution environment, the first task processing request is reprocessed. It should be noted that, in an example, the task processing request related to the environment is directly processed by the second server, and the task engine does not need to be started for processing.

In an example, to reduce interaction between the first server and the external memory and also to avoid storing excessive data into the external memory, the first server may determine whether the first task processing request is related to the task execution environment before storing the first task processing request into the external memory. When the first task processing request is related to the task execution environment, the first server stores the first task processing request and the identifier of the client correspondingly into the external memory. When the first task processing request is not related to the task execution environment, the first server does not need to store the first task processing request and the identifier of the client correspondingly into the external memory.

It can be seen from the foregoing description that, in the solution of this embodiment of this application, after the first server is faulty, another server such as the second server may determine the information of the task engine based on the information of the task engine and the identifier of the client that are stored correspondingly in the external memory and further establish a connection to the task engine, so as to use the task engine to continue to process the task initiated by the client. It can be seen that, in this solution, even if the first server is faulty, processing of the task initiated by the client is not interrupted, so that reliability of task processing is improved.

Next, a task processing method performed by the second server is described by using an example in which the first server is faulty, and the second server establishes a connection to the client and continues to process the task related to the client.

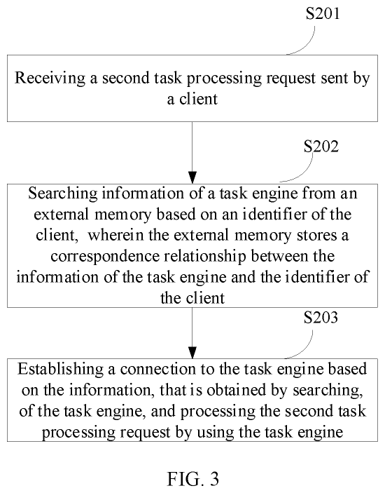

FIG. 3 is a schematic flowchart of another task processing method provided by an embodiment of this application. The method shown in FIG. 3 may be performed by a second server. The second server is not specifically limited in this embodiment of this application. In an example, if the method shown in FIG. 3 is applied to the application scenario shown in FIG. 1, the second server may be a HiveServer2. Certainly, the second server may be another server, which is not specifically limited in this embodiment of this application.

The method, for example, may include the following steps: S201-S203.

S201: Receiving a second task processing request sent by a client.

In an example, the client may establish a connection to a second server before sending the second task processing request to the second server. As an example, the client may send a connection request to the second server. The connection request may include an identifier of the server. The second server may obtain the identifier of the client based on the connection request.

After establishing the connection between the client and the second server, the client may send the second task processing request to the second server for requesting the second server to process a corresponding task. In an example, if the method shown in FIG. 3 is applied to the scenario shown in FIG. 1, the second task processing request may be an SQL statement.

S202: Searching information of a task engine from an external memory based on an identifier of the client. The external memory stores a correspondence relationship between the information of the task engine and the identifier of the client.

S203: Establishing a connection to the task engine based on the information, that is obtained by searching, of the task engine, and processing the second task processing request by using the task engine.

After receiving the second task processing request by the client a task corresponding to the second task processing request may be processed by using the task engine.

In an example, the external memory stores the correspondence relationship between the information of the task engine and the identifier of the client. The correspondence relationship between the information of the task engine and the identifier of the client that is stored in the external memory may be stored by the first server in the external memory. The second server may search the information of the corresponding task engine from the external memory by using the identifier of the client as an index.

With regard to the task engine, the information of the task engine, and the external memory, reference may be made to the related descriptions in the foregoing S101-S103. Details are not described herein again.

After obtaining the information of the task engine, the second server may be connected to the task engine based on the information of the task engine, and after being connected to the task engine, the task corresponding to the second task processing request is processed by using the task engine. In the scenario shown in FIG. 1, the task engine may be an AM. As an example, the second server may parse the SQL statement to obtain a corresponding map or reduce task, and process the map or reduce task by using the AM.

As described above, considering that if the first server is faulty, the second server is used to process the task corresponding to the client, and in this case, the second server may need to reprocess a portion of tasks that have been processed, for example, reprocess a task related to a task execution environment. The task related to the task execution environment may be, for example, a database table that needs to be accessed. In view of this, in an example, the second server may search a historical task processing request corresponding to the client from the external memory based on the identifier of the client. The external memory stores a correspondence relationship between the identifier of the client and the historical task processing request. The correspondence relationship between the identifier of the client and the historical task processing request that is stored in the external memory may be stored by the first server in the external memory. The historical task processing request mentioned herein may be the first task processing request mentioned in S101.

In an example, the historical task processing request(s) stored in the external memory only includes a request related to the task execution environment, and does not include a request unrelated to the task execution environment. In this case, after obtaining the historical task processing request from the external memory, the second server may reprocess the historical task processing request.

In another example, the historical task processing request(s) stored in the external memory includes not only a request related to the task execution environment, but also a request unrelated to the task execution environment. In this case, after obtaining the historical task processing request from the external memory, the second server may reprocess the request related to the task execution environment in the historical task processing request.

The second server processes the request related to the task execution environment, which means that the second server directly processes the request related to the task execution environment, rather than using the task engine to process the request related to the task execution environment.

It can be seen from the foregoing description that, using this solution, when the first server that processes the task initiated by the client is faulty, the second server may determine the information of the task engine, so as to further process the second task processing request by using the task engine, thereby avoiding an interrupt in processing of the task initiated by the client, and improving reliability of task processing.

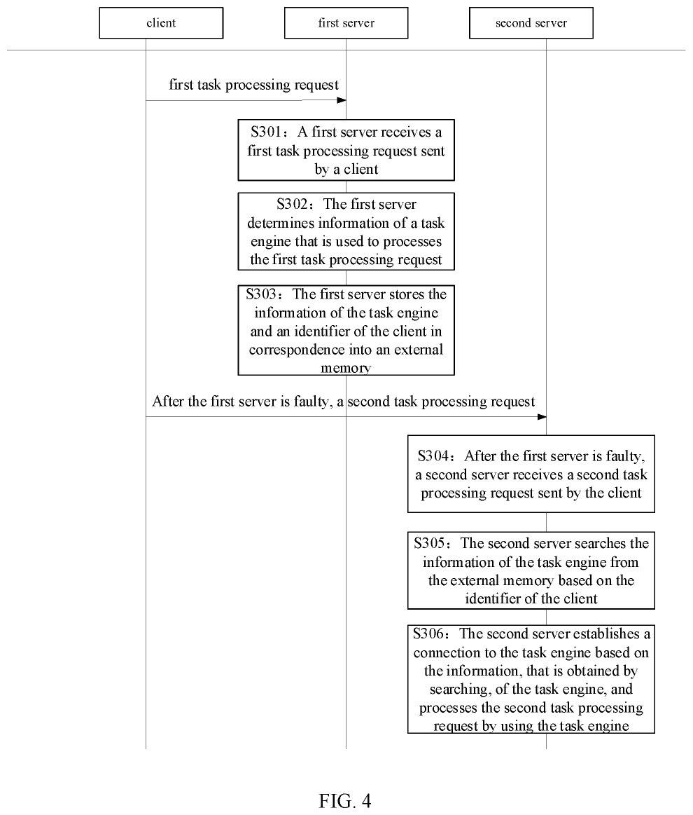

An embodiment of this application further provides a task processing method. FIG. 4 is a signaling interaction diagram of a task processing method provided by an embodiment of this application. The method shown in FIG. 4 may include the following S301-S306.

S301: A first server receives a first task processing request sent by a client.

S302: The first server determines information of a task engine that is used to processes the first task processing request.

S303: The first server stores the information of the task engine and an identifier of the client correspondingly into an external memory.

Reference may be made to the foregoing related descriptions of S101 to S103 for S301 to S303. Details are not described herein again.

S304: After the first server is faulty, a second server receives a second task processing request sent by the client.

S305: The second server searches the information of the task engine from the external memory based on the identifier of the client.

S306: The second server establishes a connection to the task engine based on the information, that is obtained by the searching, of the task engine and processes the second task processing request by using the task engine. Reference may be made to the foregoing related descriptions of S104 to S106 for a specific implementation of S304 to S306. Details are not described herein again.

In the method shown in FIG. 4, when the first server that processes the task initiated by the client is faulty, the second server may determine the information of the task engine, so as to further process the second task processing request by using the task engine, thereby avoiding an interrupt in processing of the task initiated by the client, and improving reliability of task processing.

### Exemplary Devices

Based on the methods provided in the foregoing embodiments, an embodiment of this application further provides an apparatus. The following describes the apparatus with reference to the accompanying drawings.

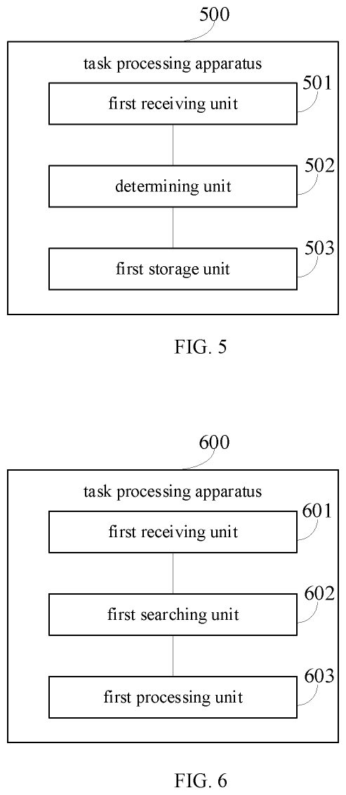

FIG. 5 is a schematic diagram of a structure of a task processing apparatus provided by an embodiment of this application. The task processing apparatus shown in FIG. 5 may be applied to a first server. The apparatus 500, for example, may specifically include: a first receiving unit 501, a determining unit 502, and a first storage unit 503.

The first receiving unit 501 is configured to receive a first task processing request sent by a client.

The determining unit 502 is configured to determine information of a task engine that is used to processes the first task processing request.

The first storage unit 503 is configured to store the information of the task engine and an identifier of the client correspondingly into an external memory.

Optionally, the apparatus further includes:

a second storage unit, configured to store the first task processing request and the identifier of the client correspondingly into the external memory.

Optionally, the second storage unit is configured to:

when the first task processing request is related to a task execution environment, store the first task processing request and the identifier of the client correspondingly into the external memory.

Optionally, the apparatus further includes:

a second receiving unit, configured to receive a connection request sent by the client, and the connection request includes the identifier of the client.

Optionally, the information of the task engine includes:

an IP address and a port number of the task engine.

Optionally, the information of the task engine further includes:

an identifier of the task engine.

Optionally, the first server is a HiveServer2.

Optionally, the first task processing request is a structured query language SQL statement, and the task engine is an application master AM.

Optionally, the external memory is a memory of a ZooKeeper.

Reference may be made to the foregoing specific descriptions of S101-S103 for a specific implementation of the apparatus 500. Details are not described herein again.

FIG. 6 is a schematic diagram of a structure of a task processing apparatus provided by an embodiment of this application. The task processing apparatus shown in FIG. 6 may be applied to a second server. The apparatus 600, for example, may specifically include: a first receiving unit 601, a first searching unit 602, and a first processing unit 603.

The first receiving unit 601 is configured to receive a second task processing request sent by a client.

The first searching unit 602 is configured to search information of a task engine from an external memory based on an identifier of the client, and the external memory stores a correspondence between the information of the task engine and the identifier of the client.

The first processing unit 603 is configured to establish a connection to the task engine based on the information, that is obtained by the searching, of the task engine and process the second task processing request by using the task engine.

Optionally, the apparatus further includes:

a second searching unit, configured to search a historical task processing request corresponding to the client from the external memory based on the identifier of the client, the historical task processing request includes a request related to a task execution environment, and the external memory includes a correspondence relationship between the identifier of the client and the historical task processing request.

The second processing unit is configured to process the request that is related to the task execution environment and that is obtained by searching.

Optionally, the apparatus further includes:

a second receiving unit, configured to receive a connection request sent by the client, and the connection request includes the identifier of the client.

Optionally, the information of the task engine includes:

an IP address and a port number of the task engine.

Optionally, the information of the task engine further includes:

an identifier of the task engine.

Optionally, the second server is a HiveServer2.

Optionally, the second task processing request is a structured query language SQL statement, and the task engine is an application master AM.

Optionally, the external memory is a memory of a ZooKeeper.

Reference may be made to the foregoing specific descriptions of S201 to S203 for a specific implementation of the apparatus 600. Details are not described herein again.

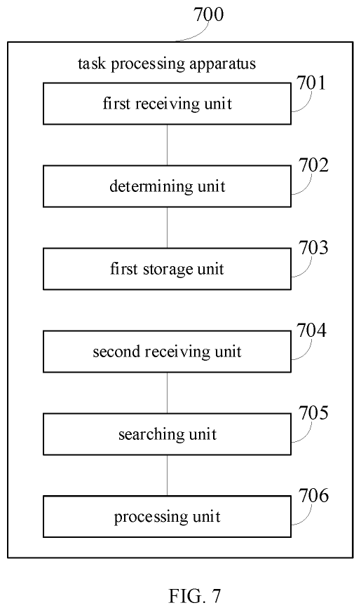

FIG. 7 is a schematic diagram of a structure of a task processing apparatus provided by an embodiment of this application. The task processing apparatus shown in FIG. 7 may be applied to a first server and a second server. The apparatus 700, for example, may specifically include: a first receiving unit 701, a determining unit 702, and a first storage unit 703 that are applied to the first server, and a second receiving unit 704, a searching unit 705, and a processing unit 706 that are applied to the second server.

The first receiving unit 701 is configured to receive a first task processing request sent by a client.

The determining unit 702 is configured to determine information of a task engine that is used to process the first task processing request.

The first storage unit 703 is configured to store the information of the task engine and an identifier of the client correspondingly into an external memory.

The second receiving unit 704 is configured to: after the first server is faulty, receive a second task processing request sent by the client.

The searching unit 705 is configured to search the information of the task engine from the external memory based on the identifier of the client.

The processing unit 706 is configured to establish a connection to the task engine based on the information, that is obtained by searching, of the task engine and process the second task processing request by using the task engine.

Reference may be made to the foregoing specific descriptions of S301 to S306 for a specific implementation of the apparatus 700. Details are not described herein again.

An embodiment of this application further provides a device, including a processor and a memory.

The processor is configured to perform instructions stored in the memory, so that the device performs the task processing methods provided in the foregoing method embodiments.

An embodiment of this application provides a computer-readable storage medium, including instructions. The instructions instruct a device to perform the task processing methods provided in the foregoing method embodiments.

An embodiment of this application further provides a computer program product. When the computer program product is run on a computer, the computer is enabled to perform the task processing methods provided in the foregoing method embodiments.

Other embodiments of the present application will be apparent to those skilled in the art from consideration of the specification and practice of the disclosure disclosed herein. This application is intended to cover any variations, uses, or adaptations of the present application, and these variations, uses, or adaptations of the present application follow the general principles of the present application and include common general knowledge or customary technical means in the art not disclosed in this disclosure. The specification and embodiments be considered as exemplary only, with a true scope and spirit of the present application is indicated by the following claims.

It should be understood that the present application is not limited to the exact construction that has been described above and illustrated in the accompanying drawings, and that various modifications and changes may be made without departing from the scope thereof. The scope of the present application is limited only by the appended claims.

The foregoing is merely a preferred embodiment of the present application, and is not intended to limit the present application, and any modification, equivalent replacement, improvement, etc. made within the spirit and principle of the present application should be included within the protection scope of the present application.

1. A task processing method, wherein the method is applied to a first server, and the method comprises:
receiving a first task processing request sent by a client;
determining information of a task engine that is used to process the first task processing request; and
storing the information of the task engine and an identifier of the client correspondingly into an external memory.

2. The method according to claim 1, wherein the method further comprises:
storing the first task processing request and the identifier of the client correspondingly into the external memory.

3. The method according to claim 2, wherein the storing the first task processing request and the identifier of the client correspondingly into the external memory comprises:
when the first task processing request is related to a task execution environment, storing the first task processing request and the identifier of the client correspondingly into the external memory.

4. The method according to claim 1, wherein the method further comprises:
receiving a connection request sent by the client, wherein the connection request comprises the identifier of the client.

5. The method according to claim 1, wherein the information of the task engine comprises:
an IP address and a port number of the task engine.

6. The method according to claim 5, wherein the information of the task engine further comprises:
an identifier of the task engine.

7. The method according to claim 1, wherein the first server is a HiveServer2.

8. The method according to claim 7, wherein the first task processing request is a structured query language SQL statement, and the task engine is an application master AM.

9. The method according to claim 1, wherein the external memory is a memory of a ZooKeeper.

10. A task processing method, wherein the method is applied to a second server, and the method comprises:
receiving a second task processing request sent by a client;
searching information of a task engine from an external memory based on an identifier of the client, wherein a correspondence relationship between the information of the task engine and the identifier of the client is stored in the external memory; and
establishing a connection to the task engine based on the information, that is obtained by the searching, of the task engine, and processing the second task processing request by using the task engine.

11. The method according to claim 10, wherein the method further comprises:
searching a historical task processing request corresponding to the client from the external memory based on the identifier of the client, wherein the historical task processing request comprises a request that is related to a task execution environment, and the external memory comprises a correspondence relationship between the identifier of the client and the historical task processing request; and
processing the request that is related to the task execution environment and that is obtained by the searching.

12. The method according to claim 10, wherein the method further comprises:
receiving a connection request sent by the client, wherein the connection request comprises the identifier of the client.

13. The method according to claim 10, wherein the information of the task engine comprises:
an IP address and a port number of the task engine.

14. The method according to claim 13, wherein the information of the task engine further comprises:
an identifier of the task engine.

15. The method according to claim 1, wherein the second server is a HiveServer2.

16. The method according to claim 15, wherein the second task processing request is a structured query language SQL statement, and the task engine is an application master AM.

17. The method according to claim 1, wherein the external memory is a memory of a ZooKeeper.

18. A task processing method, wherein the method comprises:
receiving, by a first server, a first task processing request sent by a client;
determining, by the first server, information of a task engine that is used to process the first task processing request;
storing, by the first server, the information of the task engine and an identifier of the client correspondingly into an external memory;
receiving, by a second server, a second task processing request sent by the client, after the first server is faulty;
searching, by the second server, the information of the task engine from the external memory based on the identifier of the client; and
establishing, by the second server, a connection to the task engine based on the information, that is obtained by the searching, of the task engine, and processing the second task processing request by using the task engine.

19.-21. (canceled)

22. A device, wherein the device comprises a processor and a memory, wherein
the processor is configured to execute instructions stored in the memory, so that the device performs the method according to claim 1.

23. A computer-readable storage medium, comprising instructions,
wherein the instructions instruct a device to perform the method according to claim 1.

24. (canceled)
